(19) United States
(12) Patent Application Publication
(10) Pub. No.: US 2014/0127654 A1
(43) Pub. Date: May 8, 2014

(54) PAWS

(71) Applicant: Renee Michelle Sotolar, Columbia, MO (US)

(72) Inventor: Renee Michelle Sotolar, Columbia, MO (US)

(21) Appl. No.: 13/671,563

(22) Filed: Nov. 8, 2012

(51) Int. Cl. G09B 19/00

(52) U.S. Cl. CPC G09B 19/00
USPC 434/219

(57) ABSTRACT

A personal computer external hardware touchpad and coordinating hand held activator attachment (mouse) linked to computer through USB cable, and coordinated with accompanying software will mimic and cause computer monitor to display a stored image of an actual ultrasound scan on a live being or a computer generated likeness, through the constant direct pressure and interaction of the hardware and software program. Some existing computer keyboard functions will temporarily be altered by the software to coordinate with the hardware and displayed image.

### CROSS-REFERENCE TO RELATED APPLICATIONS

Not Applicable

### BACKGROUND OF THE INVENTION

This invention, PAWS, is directly related to the field of diagnostic medical ultrasound. There is no prior invention such as this. All existing interactive scanning instructional aids require the use of phantoms or life like size mannequins which require an actual ultrasound machine for use; an impractical setting for an individual to have access to on a regular basis, thereby severely limiting an individual's ability for educational instruction and practice outside of an institution or clinical setting which possess these objects.

### BRIEF SUMMARY OF THE INVENTION

PAWS is a computer software/hardware combination which consists of a specialized touchpad that functions with touch screen technology of one form or more, to be used in combination with a coordinating “mouse” controller (in the shape of an ultrasound transducer), that are programmed to interact with each other through coordinating program software that will mimic an actual ultrasound scan on a patient on the computer display. This invention does not require the use of an actual ultrasound machine nor patient.

This invention brings a practical opportunity for health care workers to practice ultrasound scanning protocols, master scanning techniques, and improve ability to identify pathology through a personal computer interactive format that can be accessed at their convenience without the need for expensive machines nor real patients.

The object of the invention is to provide a convenient, practical resource and method to aid health care workers engaged in sonography, students, educators, and physicians to master ultrasound scanning ability through a personal computer without the need for an actual ultrasound machine nor patient.

### BRIEF DESCRIPTION OF THE SEVERAL VIEWS OF THE DRAWING

FIG. 1 shows a general rendition of the PAWS touchpad with top USB cable functioning as the interface between PAWS touchpad and the user's computer. The lower USB port functioning as the port into which the PAWS mouse will be connected.

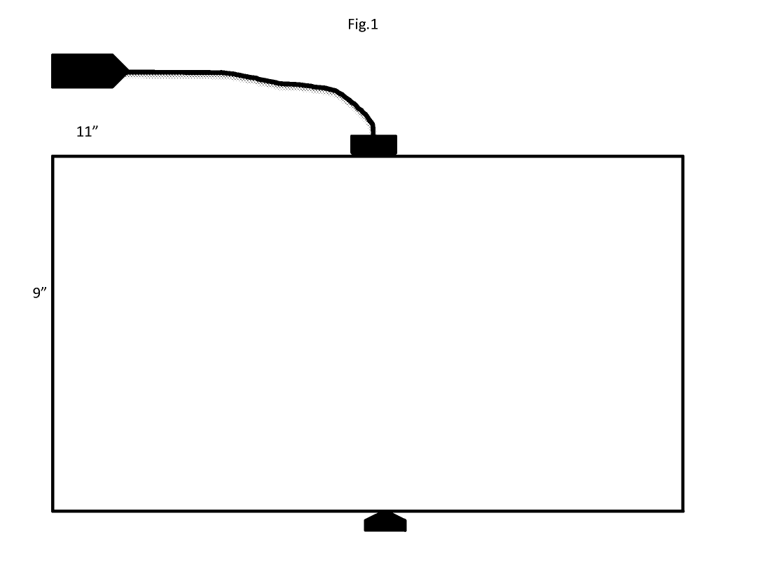

FIG. 2 shows a general rendition of the PAWS transducer shaped “mouse” controller. The USB cable will function as the interface between the PAWS “mouse” controller and the PAWS touchpad, and will insert into the bottom of the PAWS specialized touchpad at the port.

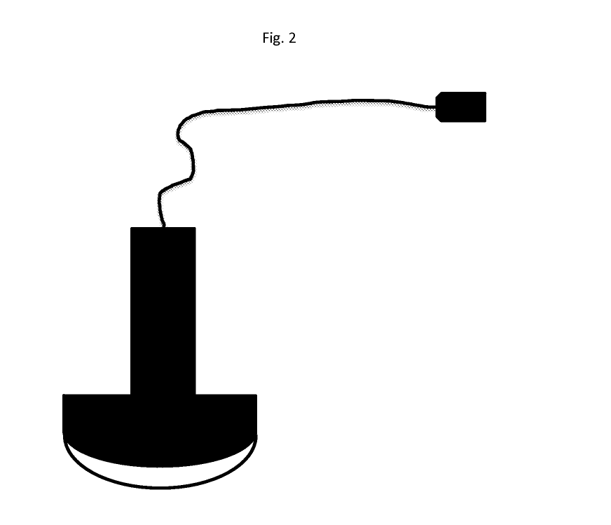

### DETAILED DESCRIPTION OF THE INVENTION

PAWS is my invention for a computer software/hardware combination instructional aid for use by sonography students, medical students, health care workers, educators, etc. who are engaged in ultrasound to improve their scanning skills with the convenience of a personal computer method that will not require the use of an actual ultrasound machine nor patient. The invention is PAWS (personal advancement workstation for sonographers), which is a way for anyone who is engaged in health professions who performs sonographic exams to have a virtual interactive resource for practicing scanning protocols to improve the level of skill needed for real time exams.

PAWS consists of a specialized touchpad that utilizes touch screen technology of one form or more, a coordinated “mouse” controller (in the shape of an ultrasound transducer) that works directly with the specialized touchpad, and a related computer software program.

The software program will be designed to work directly with the precise, coordinated contact between the specialized touch screen technology touchpad and “mouse” controller to display an image on the computer screen that will reveal a stored, actual sonographic image obtained during a real sonographic exam, or a computer generated likeness. The ability to produce the image on the computer screen will be directly related to the precise interaction between the specialized touchpad and the “mouse” controller. Without the continuous pressure and “mouse” movement on the touchpad, there will be no image on the display unless the keyboard ‘freeze’ function is enabled (Reference [0004]).

The computer program will also include the interaction and coordination of the existing computer keyboard functions to include an override of certain keys on the right side of the keyboard that will temporarily function in a different manner that is not consistent with usual use. These certain keys on the right side of the existing user's keyboard, such as Home, PgUp, PgDn, and End, along with the ‘arrow keys’ (of particular function for intensity increase or decrease), will become image optimization controls to manipulate the display quality of the displayed image. The existing keyboard ‘Enter’ key will temporarily function with the PAWS software program as a ‘save’ function. The existing keyboard ‘Shift’ key will temporarily function with the PAWS program as a ‘freeze’ function.

The invention claimed is:

1. PAWS (personal advancement workstation for sonographers), a software/hardware combination which consists of a specialized touch pad that functions with touch screen technology of one form or more, to be used in combination with a coordinating “mouse” controller (in the shape of an ultrasound transducer), that are programmed to interact with each other through a software program that will mimic an actual ultrasound scan on a patient.

2. PAWS of claim 1: The hardware will be a specialized PAWS touchscreen technology touchpad and specialized coordinating PAWS ultrasound transducer shaped “mouse” controller that will be connected via USB cable to a computer, that when PAWS “mouse” controller is moved over PAWS touchpad, they will function together as preprogrammed corresponding points are precisely passed over to work directly with the PAWS software program to reveal a stored image onto the computer display that is an actual sonographic image, or a computer generated likeness image.

3. PAWS of claim 1-2: The software of PAWS will include several instructional modules that will include several individual and combinations of organs and vessels in the human body consisting either of actual stored sonographic images, or computer generated likenesses. The ability to switch between planes for each module will be incorporated and linked to PAWS “mouse” controller and PAWs touchpad orientation recognition.

4. PAWS of claims 1-3: The PAWS software program will directly coordinate with the PAWS touchpad and PAWS “mouse” controller, and with the existing user's keyboard functions, as well as temporarily alter the usual function of a few certain existing keyboard keys that will take on a temporary new function to work with the PAWS software program, functioning in the same manner as to mimic image optimization controls of an actual ultrasound machine.
